(19) United States
(12) Patent Application Publication
(10) Pub. No.: US 2015/0380746 A1
(43) Pub. Date: Dec. 31, 2015

(54) FUEL CELL AND METHOD OF PRODUCING THE FUEL CELL

(71) Applicant: HONDA MOTOR CO., LTD., TOKYO (JP)

(72) Inventors: Masahiro FUKUTA, TOCHIGI-KEN (JP); Masami KURIMOTO, UTSUNOMIYA-SHI (JP); Yohei KATAOKA, UTSUNOMIYA-SHI (JP); Yasuhide FUKUSHIMA, UTSUNOMIYA-SHI (JP); Junichi NAKAMURA, SHIMOTSUKE-SHI (JP); Takahiro TANAKA, UTSUNOMIYA-SHI (JP); Kohei YOSHIDA, UTSUNOMIYA-SHI (JP)

(21) Appl. No.: 14/749,773

(22) Filed: Jun. 25, 2015

(30) Foreign Application Priority Data
Jun. 27, 2014 (JP) 2014-132613
Jun. 27, 2014 (JP) 2014-132826

(51) Int. Cl. H01M 8/02

(52) U.S. Cl. CPC H01M 8/0273

(57) ABSTRACT

A frame equipped membrane electrode assembly is formed by joining a membrane electrode assembly (MEA) having different sizes of components together with a resin frame member. A frame shaped adhesive sheet is provided between an inner extension of the resin frame member and an outer marginal portion of the MEA. An inner marginal portion of the adhesive sheet includes an overlapped portion, which overlaps in an electrode thickness direction with the surface of an outer marginal portion of a second gas diffusion layer.

### CROSS-REFERENCE TO RELATED APPLICATIONS

This application is based upon and claims the benefit of priority from Japanese Patent Applications No. 2014-132613 filed on Jun. 27, 2014 and No. 2014-132826 filed on Jun. 27, 2014, the contents all of which are incorporated herein by reference.

### BACKGROUND OF THE INVENTION

1. Field of the Invention

The present invention relates to a fuel cell including a frame equipped membrane electrode assembly formed by joining a membrane electrode assembly having different sizes of components and a resin frame member. Further, the present invention relates to a method of producing such a fuel cell.

2. Description of the Related Art

In general, a solid polymer electrolyte fuel cell employs a solid polymer electrolyte membrane. The solid polymer electrolyte membrane is a polymer ion exchange membrane. The fuel cell includes a membrane electrode assembly (MEA) in which an anode and a cathode are provided on both sides of the solid polymer electrolyte membrane. Each of the anode and the cathode includes a catalyst layer (electrode catalyst layer) and a gas diffusion layer (porous carbon). In the fuel cell, the membrane electrode assembly is sandwiched between separators (bipolar plates). A predetermined number of fuel cells are stacked together to make up a fuel cell stack. During use thereof, for example, the fuel cell stack is mounted in a vehicle and serves as an in-vehicle fuel cell stack.

In certain cases, the membrane electrode assembly has a structure in which the components of the MEA have different sizes, i.e., the surface size of one of the gas diffusion layers is smaller than the surface size of the solid polymer electrolyte membrane, and the surface size of the other of the gas diffusion layers is the same as the surface size of the solid polymer electrolyte membrane. In this regard, for the purpose of reducing the amount of expensive material used for the solid polymer electrolyte membrane, and in order to protect the thin solid polymer electrolyte membrane, which is low in strength, frame equipped MEAs including resin frame members have been adopted.

For example, a membrane electrode assembly such as that disclosed in Japanese Laid-Open Patent Publication No. 2007-066766 is known. As shown in FIG. 20, in the membrane electrode assembly, an anode catalyst layer 2a and an anode gas diffusion layer 2b are provided on one surface of a membrane 1, and a cathode catalyst layer 3a and a cathode gas diffusion layer 3b are provided on the other surface of the membrane 1, thereby forming an MEA 4 having different sizes of components.

The surface size of the anode gas diffusion layer 2b is larger than the surface size of the cathode gas diffusion layer 3b. The outer end of the membrane 1, which lies adjacent to the cathode gas diffusion layer 3b, and a gasket structural body 5 are joined together through an adhesion portion 6.

### SUMMARY OF THE INVENTION

In Japanese Laid-Open Patent Publication No. 2007-066766, the outer marginal portion (flat surface) of the membrane 1, which lies adjacent to the cathode gas diffusion layer 3b, and the flat surface of a thin inner portion 5a of the gasket structural body 5 are joined together through the adhesion portion 6 in a form of a frame shaped flat surface. Therefore, upon joining the MEA 4 having different sizes of components and the gasket structural body 5, the adhesion strength tends to be low, and peeling or other damage may occur at the end of the MEA 4.

The present invention has been made in order to solve problems of this type. An object of the present invention is to provide a fuel cell and a method of producing the fuel cell, in which it is possible to reliably join a membrane electrode assembly having different sizes of components and a resin frame member together with a simple structure and process.

The present invention relates to a fuel cell including a frame equipped membrane electrode assembly formed by joining a membrane electrode assembly having different sizes of components and a resin frame member. Further, the present invention relates to a method of producing such a fuel cell. The membrane electrode assembly includes a solid polymer electrolyte membrane, a first electrode provided on one surface of the solid polymer electrolyte membrane, and a second electrode provided on another surface of the solid polymer electrolyte membrane. The first electrode includes a first catalyst layer and a first gas diffusion layer. The second electrode includes a second catalyst layer and a second gas diffusion layer. A surface size of the first gas diffusion layer is larger than a surface size of the second gas diffusion layer.

The resin frame member has a frame shape around an outer end of the solid polymer electrolyte membrane, and has a step portion forming a thin inner extension that protrudes toward the second gas diffusion layer.

In the fuel cell, a frame shaped adhesive sheet is provided between the inner extension of the resin frame member and an outer marginal portion of the membrane electrode assembly. Further, an inner marginal portion of the adhesive sheet includes an overlapped portion, which overlaps in an electrode thickness direction with a surface of an outer marginal portion of the second gas diffusion layer.

Further, according to another aspect of the present invention, the production method includes the steps of producing the membrane electrode assembly and the resin frame member separately, and producing a frame shaped adhesive sheet having an inner opening size which is smaller than an outer size of the second gas diffusion layer. The production method further includes the step of adhering the inner extension of the resin frame member and an outer marginal portion of the membrane electrode assembly together through the adhesive sheet.

Further, according to yet another aspect of the present invention, the production method includes the steps of producing the membrane electrode assembly and the resin frame member separately, and molding a frame shaped adhesive sheet having a shape that matches with a shape of an adhesion portion provided between the membrane electrode assembly and the resin frame member. The production method further includes the step of adhering the inner extension of the resin frame member and an outer marginal portion of the membrane electrode assembly together through the molded adhesive sheet.

In the present invention, the frame shaped adhesive sheet is interposed between the inner extension of the resin frame member and the outer marginal portion of the membrane electrode assembly. The inner marginal portion of the adhesive sheet overlaps in an electrode thickness direction with the surface of an outer marginal portion of the second gas diffusion layer. With such a structure, the resin frame member and the membrane electrode assembly are joined together firmly and reliably through the adhesive sheet.

Accordingly, with a simple structure and process, for example, it becomes possible to reliably suppress peeling of the membrane electrode assembly and the resin frame member from each other.

Further, in the present invention, the frame shaped adhesive sheet is molded beforehand, so as to have a shape that matches with the shape of an adhesion portion between the membrane electrode assembly and the resin frame member. In such a structure, when the molded adhesive sheet is interposed at the adhesion portion between the inner extension of the resin frame member and the outer marginal portion of the membrane electrode assembly, no gaps are formed at the adhesion portion due to molding failures of the adhesive sheet.

Accordingly, at the adhesion portion, it is possible to suppress stagnation of gas or air as much as possible. Further, with a simple process, it becomes possible to reliably and firmly join the membrane electrode assembly and the resin frame member together.

The above and other objects, features and advantages of the present invention will become more apparent from the following description when taken in conjunction with the accompanying drawings, in which preferred embodiments of the present invention are shown by way of illustrative example.

### BRIEF DESCRIPTION OF THE DRAWINGS

FIG. 1 is an exploded perspective view showing main components of a solid polymer electrolyte fuel cell according to a first embodiment of the present invention;

FIG. 2 is a cross sectional view showing the fuel cell, taken along line II-II in FIG. 1;

FIG. 3 is a front view showing an anode of a frame equipped membrane electrode assembly having different sizes of components, which constitutes the fuel cell;

FIG. 4 is a view showing a method of producing the frame equipped membrane electrode assembly;

FIG. 5 is a view showing a method of producing the frame equipped membrane electrode assembly;

FIG. 6 is a view showing a method of producing the frame equipped membrane electrode assembly;

FIG. 7 is a cross sectional view showing main components of a solid polymer electrolyte fuel cell according to a second embodiment of the present invention;

FIG. 8 is a cross sectional view showing main components of a solid polymer electrolyte fuel cell according to a third embodiment of the present invention;

FIG. 9 is a view showing a method of producing the frame equipped membrane electrode assembly in a production method according to the third embodiment of the present invention;

FIG. 10 is a view showing a method of producing the frame equipped membrane electrode assembly according to the third embodiment;

FIG. 11 is a view showing a method of producing the frame equipped membrane electrode assembly according to the third embodiment;

FIG. 12 is a view showing a method of producing the frame equipped membrane electrode assembly according to the third embodiment;

FIG. 13 is a view showing a method of producing the frame equipped membrane electrode assembly in a production method according to a fourth embodiment of the present invention;

FIG. 14 is a view showing a method of producing the frame equipped membrane electrode assembly according to the fourth embodiment;

FIG. 15 is a view showing a method of producing the frame equipped membrane electrode assembly according to the fourth embodiment;

FIG. 16 is a view showing a method of producing the frame equipped membrane electrode assembly in a production method according to a fifth embodiment of the present invention;

FIG. 17 is a view showing a method of producing the frame equipped membrane electrode assembly according to the fifth embodiment;

FIG. 18 is a view showing a method of producing the frame equipped membrane electrode assembly according to the fifth embodiment;

FIG. 19 is a cross sectional view showing a die device used in a method of producing a fuel cell according to a sixth embodiment; and

FIG. 20 is a view showing the membrane electrode assembly disclosed in Japanese Laid-Open Patent Publication No. 2007-066766.

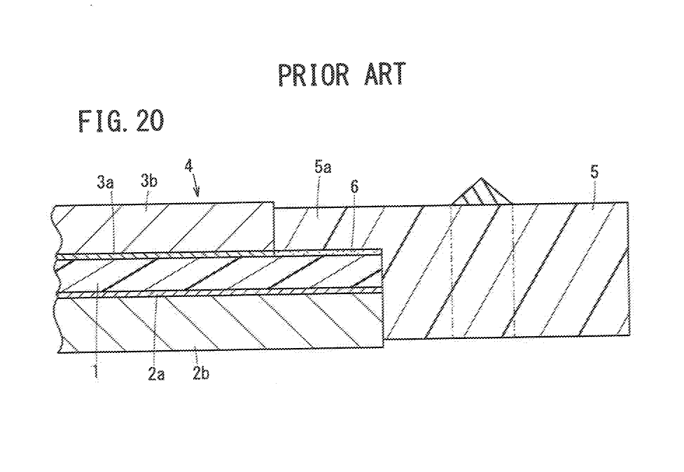

### DESCRIPTION OF THE PREFERRED EMBODIMENTS

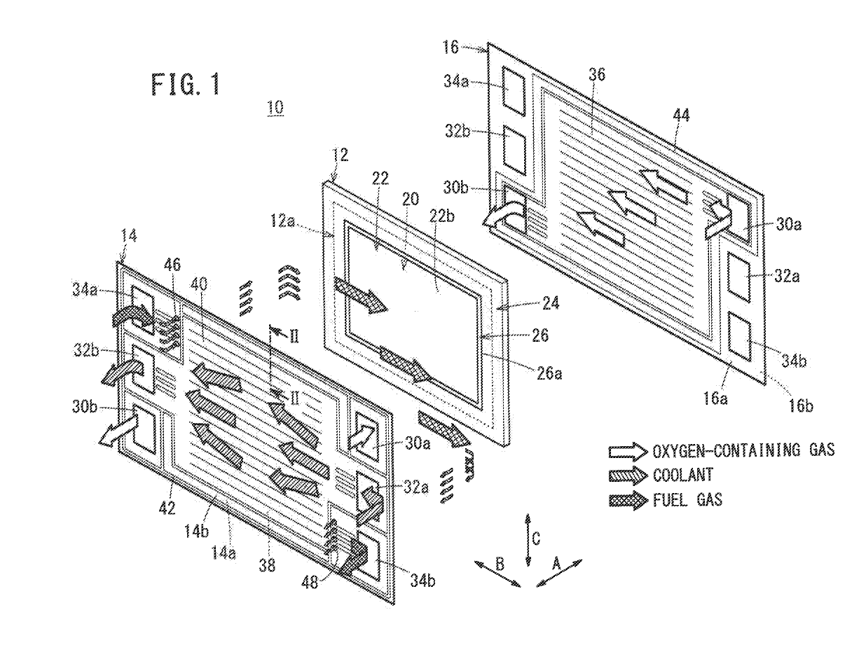

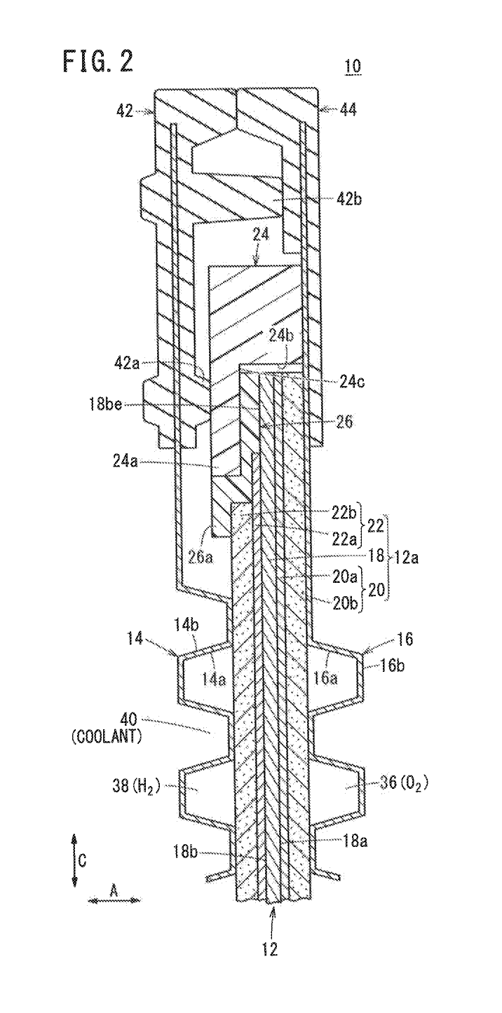

A plurality of solid polymer electrolyte fuel cells 10 according to a first embodiment of the present invention shown in FIGS. 1 and 2 are stacked together, e.g., in a horizontal direction as indicated by the arrow A, in order to form a fuel cell stack that is mounted in a vehicle, for example.

The fuel cell 10 is formed by sandwiching a frame equipped membrane electrode assembly 12 between a first separator 14 and a second separator 16. For example, the first separator 14 and the second separator 16 are made of metal plates such as steel plates, stainless steel plates, aluminum plates, plated steel sheets, or metal plates having anti-corrosive surfaces formed by a surface treatment. Alternatively, carbon members may be used as the first separator 14 and the second separator 16.

As shown in FIG. 2, the frame equipped membrane electrode assembly 12 includes an MEA (a membrane electrode assembly having different sizes of components) 12a. The MEA 12a includes a solid polymer electrolyte membrane (cation exchange membrane) 18, and a cathode (first electrode) 20 and an anode (second electrode) 22 sandwiching the solid polymer electrolyte membrane 18 therebetween. The solid polymer electrolyte membrane 18 is formed by impregnating a thin membrane of perfluorosulfonic acid with water, for example. A fluorine based electrolyte may be used as the solid polymer electrolyte membrane 18. Alternatively, an HC (hydrocarbon) based electrolyte may be used as the solid polymer electrolyte membrane 18.

The surface size of the anode 22 is smaller than the surface sizes of the solid polymer electrolyte membrane 18 and the cathode 20. Alternatively, the arrangement positions of the anode 22 and the cathode 20 may be reversed, such that the surface size of the cathode 20 is smaller than the surface sizes of the solid polymer electrolyte membrane 18 and the anode 22. In this case, the anode 22 is referred to as the first electrode, and the cathode 20 is referred to as the second electrode.

The cathode 20 is provided on one surface 18a of the solid polymer electrolyte membrane 18, and the anode 22 is provided on the other surface 18b of the solid polymer electrolyte membrane 18.

The cathode 20 includes a first electrode catalyst layer (first catalyst layer) 20a joined to the surface 18a of the solid polymer electrolyte membrane 18, and a first gas diffusion layer 20b that is stacked on the first electrode catalyst layer 20a. The surface size of the first electrode catalyst layer 20a and the surface size of the first gas diffusion layer 20b are the same. More specifically, the surface size of the first electrode catalyst layer 20a and the surface size of the first gas diffusion layer 20b are the same as the surface size of the solid polymer electrolyte membrane 18.

The anode 22 includes a second electrode catalyst layer (second catalyst layer) 22a that is joined to the surface 18b of the solid polymer electrolyte membrane 18, and a second gas diffusion layer 22b that is stacked on the second electrode catalyst layer 22a. The surface size of the second electrode catalyst layer 22a is larger than the surface size of the second gas diffusion layer 22b (or the same as the surface size of the second gas diffusion layer 22b). The surface size of the first electrode catalyst layer 20a is larger than the surface size of the second electrode catalyst layer 22a. However, the present invention is not limited in this respect. The first electrode catalyst layer 20a and the second electrode catalyst layer 22a may have the same surface size.

Each of the first electrode catalyst layer 20a and the second electrode catalyst layer 22a includes catalyst particles formed by platinum particles supported on carbon black. As an ion conductive binder, for example, polymer electrolyte is used. Catalyst paste formed by mixing the catalyst particles uniformly in a solution of the polymer electrolyte is printed, applied (coated), or transferred onto both surfaces 18a, 18b of the solid polymer electrolyte membrane 18 to thereby form a catalyst coated membrane (CCM).

Each of the first gas diffusion layer 20b and the second gas diffusion layer 22b is formed by applying an underlying layer (intermediate layer) containing carbon black and PTFE (polytetrafluoroethylene) particles to a carbon paper. The underlying layer and the carbon paper have the same surface size. The underlying layer is provided on the first gas diffusion layer 20b on the side adjacent to the first electrode catalyst layer 20a, and on the second gas diffusion layer 22b on the side adjacent to the second electrode catalyst layer 22a. The underlying layer may be provided as necessary. The surface size of the first gas diffusion layer 20b is larger than the surface size of the second gas diffusion layer 22b.

As shown in FIGS. 1 and 2, the frame equipped membrane electrode assembly 12 includes a resin frame member 24, which is joined to (adhered to) the MEA 12a having different sizes of components. For example, the resin frame member 24 is made of PPS (Poly Phenylene Sulfide), PPA (polyphthalamide), PEN (polyethylene naphthalate), PES (polyethersulfone), LCP (liquid crystal polymer), PVDF (polyvinylidene fluoride), silicone resin, fluororesin, or m-PPE (modified Poly Phenylene Ether) resin. Alternatively, the resin frame member 24 may be made of PET (polyethylene terephthalate), PBT (polybutylene terephthalate), or modified polyolefin.

The resin frame member 24 has a frame shape, and includes a stepped portion 24c forming a thin inner extension 24a. The inner extension 24a of the resin frame member 24 protrudes toward the outer end of the anode 22, so as to face toward an outer marginal portion 18be of the solid polymer electrolyte membrane 18. The outer marginal portion 18be of the solid polymer electrolyte membrane 18 extends outwardly beyond the outer end of the second gas diffusion layer 22b of the anode 22.

The inner extension 24a extends inwardly by a predetermined length from an inner wall surface 24b of the resin frame member 24. In addition, the inner extension 24a covers an area from the outer marginal portion 18be of the solid polymer electrolyte membrane 18 to the front end of the second electrode catalyst layer 22a. A predetermined gap is formed between the inner wall surface 24b and the front end of the MEA 12a.

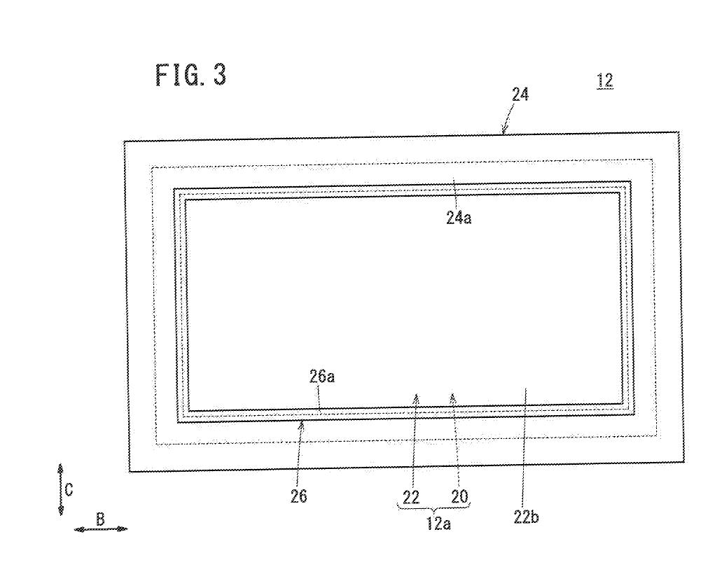

A frame shaped adhesive sheet 26 is disposed between the outer marginal portion 18be of the solid polymer electrolyte membrane 18 and the inner extension 24a of the resin frame member 24. As shown in FIGS. 2 and 3, the inner marginal end of the adhesive sheet 26 includes an overlapped portion 26a, which overlaps in the stacking direction (in the electrode thickness direction) with the outer marginal end surface of the second gas diffusion layer 22b. The adhesive sheet 26 includes an overlapped portion, which directly contacts the outer end portion of the second electrode catalyst layer 22a. The outer marginal portion of the adhesive sheet 26 is aligned substantially with the front ends of the solid polymer electrolyte membrane 18 and the cathode 20. As shown in FIG. 2, there is no difference in height over the outer surface of the overlapped portion 26a from the outer surface of the inner extension 24a of the resin frame member 24, and the overlapped portion 26a is formed from the same flat surface.

A thermoplastic or thermosetting adhesive, for example, is used as the adhesive sheet 26. According to the first embodiment, the adhesive sheet 26 is formed using an ester based, acrylic based, or urethane based hot melt sheet. The hot melt sheet provides an adhesive in a form of a solid sheet, which can be melted when heated, and the adhesive is solidified when cooled to thereby obtain an adhesive force.

As shown in FIG. 1, at one end of the fuel cell 10 in a horizontal direction as indicated by the arrow B, an oxygen-containing gas supply passage 30a, a coolant supply passage 32a, and a fuel gas discharge passage 34b are provided. The oxygen-containing gas supply passage 30a, the coolant supply passage 32a, and the fuel gas discharge passage 34b extend through the fuel cell 10 in the stacking direction as indicated by the arrow A. An oxygen-containing gas is supplied through the oxygen-containing gas supply passage 30a, and the coolant is supplied through the coolant supply passage 32a. A fuel gas such as a hydrogen-containing gas is discharged through the fuel gas discharge passage 34b. The oxygen-containing gas supply passage 30a, the coolant supply passage 32a, and the fuel gas discharge passage 34b are arranged sequentially in a vertical direction as indicated by the arrow C.

At the other end of the fuel cell 10 in the direction of the arrow B, a fuel gas supply passage 34a for supplying the fuel gas, a coolant discharge passage 32b for discharging the coolant, and an oxygen-containing gas discharge passage 30b for discharging the oxygen-containing gas are provided. The fuel gas supply passage 34a, the coolant discharge passage 32b, and the oxygen-containing gas discharge passage 30b extend through the fuel cell 10 in the direction of the arrow A. The fuel gas supply passage 34a, the coolant discharge passage 32b, and the oxygen-containing gas discharge passage 30b are arranged sequentially in the direction of the arrow C.

The second separator 16 has an oxygen-containing gas flow field 36 on a surface 16a that faces toward the frame equipped membrane electrode assembly 12. The oxygen-containing gas flow field 36 is connected to the oxygen-containing gas supply passage 30a and the oxygen-containing gas discharge passage 30b.

The first separator 14 has a fuel gas flow field 38 on a surface 14a that faces toward the frame equipped membrane electrode assembly 12. The fuel gas flow field 38 is connected to the fuel gas supply passage 34a and the fuel gas discharge passage 34b. A coolant flow field 40 is formed between a surface 14b of the first separator 14 and a surface 16b of the second separator 16. The coolant flow field 40 is connected to the coolant supply passage 32a and the coolant discharge passage 32b.

As shown in FIGS. 1 and 2, a first seal member 42 is formed integrally with the surfaces 14a, 14b of the first separator 14 around the outer end of the first separator 14. A second seal member 44 is formed integrally with the surfaces 16a, 16b of the second separator 16 around the outer end of the second separator 16.

As shown in FIG. 2, the first seal member 42 includes a first ridge seal 42a, which contacts the inner extension 24a of the resin frame member 24 of the frame equipped membrane electrode assembly 12, and a second ridge seal 42b, which contacts the second seal member 44 of the second separator 16. The second seal member 44 is constituted as a flat surface seal that extends along the separator surfaces. Instead of providing the second ridge seal 42b, the second seal member 44 may have a ridge seal (not shown).

Each of the first seal member 42 and the second seal member 44 is an elastic seal member, which is made of a seal material, a cushion material, or a packing material, such as EPDM (Ethylene Propylene Diene Monomer) rubber, NBR (Nitrile Butadiene Rubber), fluoro rubber, silicone rubber, fluorosilicone rubber, butyl rubber, natural rubber, styrene rubber, chloroprene rubber, or acrylic rubber.

As shown in FIG. 1, the first separator 14 has supply holes 46 connecting the fuel gas supply passage 34a to the fuel gas flow field 38, and discharge holes 48 connecting the fuel gas flow field 38 to the fuel gas discharge passage 34b.

Next, a method of producing the frame equipped membrane electrode assembly 12 will be described below.

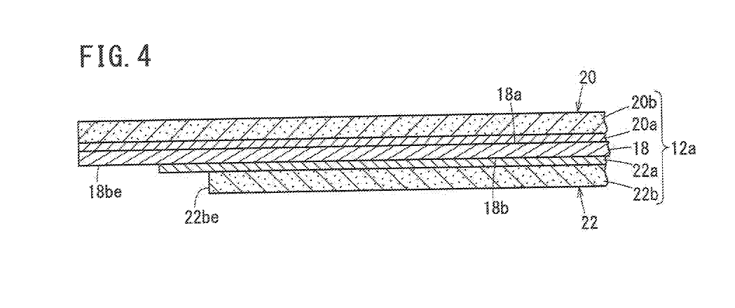

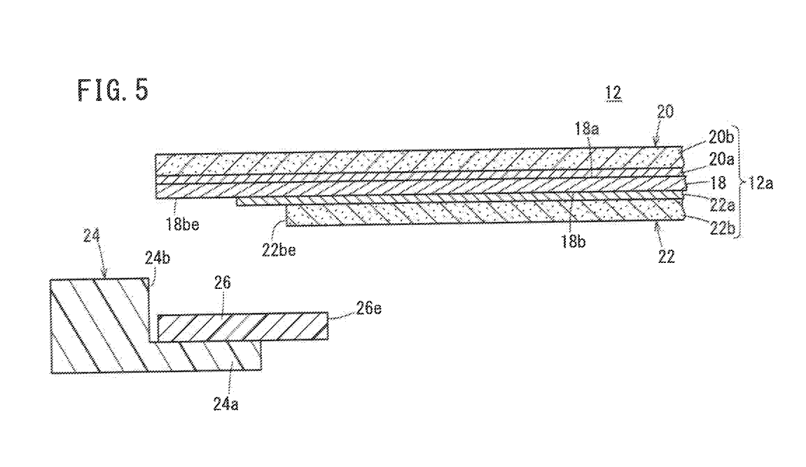

First, as shown in FIG. 4, the MEA 12a having different sizes of components is produced by interposing the solid polymer electrolyte membrane 18 between the cathode 20 and the anode 22, and hot pressing such members. On the other hand, as shown in FIG. 5, the resin frame member 24 is molded by injection molding using a die (not shown). The resin frame member 24 includes the thin inner extension 24a.

Next, the adhesive sheet (hot melt sheet) 26 is formed in a flat frame shape. The adhesive sheet 26 is placed on the inner extension 24a of the resin frame member 24, and the MEA 12a is placed in facing relation to the inner extension 24a, such that the adhesive sheet 26 is interposed between the MEA 12a and the inner extension 24a.

As shown in FIG. 5, the outer end of the adhesive sheet 26 is substantially aligned with the outer marginal portions of the solid polymer electrolyte membrane 18 and the cathode 20. Together therewith, an inner extension 26e of the adhesive sheet 26 is positioned inside of an outer marginal portion 22be of the second gas diffusion layer 22b.

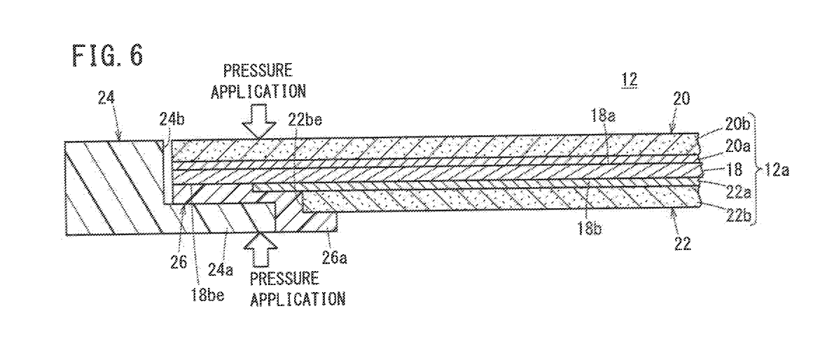

In this state, as shown in FIG. 6, the adhesive sheet 26 is sandwiched between the MEA 12a and the resin frame member 24, and is melted by heating (hot melt). In addition, a load (e.g., a pressing force or the like) is applied to the adhesive sheet 26 from both sides thereof. The adhesion method using the adhesive sheet 26 employs a hot press or a roll press. Furthermore, either one sided heating, in which heat is applied to the side of the MEA 12a or the side of the resin frame member 24, and double sided heating, in which heat is applied both to the side of the MEA 12a and the side of the resin frame member 24, may be used.

Therefore, the inner extension 24a and the solid polymer electrolyte membrane 18 are adhered together. The inner marginal portion of the adhesive sheet 26 forms an overlapped portion 26a, which overlaps in the stacking direction with the surface of the outer marginal portion of the second gas diffusion layer 22b. Thus, the frame equipped membrane electrode assembly 12 having components of different sizes is produced.

As shown in FIG. 2, the frame equipped membrane electrode assembly 12 is sandwiched between the first separator 14 and the second separator 16. The first separator 14 is placed in contact with the inner extension 24a of the resin frame member 24, such that loads are applied to the frame equipped membrane electrode assembly 12 by the first separator 14 and the second separator 16. A predetermined number of the fuel cells 10 are stacked together to form the fuel cell stack, and a tightening load is applied to the components, which are situated between respective end plates (not shown).

Operations of the fuel cell 10, which is constructed in the foregoing manner, will be described.

First, as shown in FIG. 1, an oxygen-containing gas is supplied to the oxygen-containing gas supply passage 30a, and a fuel gas such as a hydrogen-containing gas is supplied to the fuel gas supply passage 34a. In addition, a coolant such as pure water, ethylene glycol, or oil is supplied to the coolant supply passage 32a.

Thus, the oxygen-containing gas flows from the oxygen-containing gas supply passage 30a into the oxygen-containing gas flow field 36 of the second separator 16. The oxygen-containing gas moves in the direction of the arrow B, whereby the oxygen-containing gas is supplied to the cathode 20 of the MEA 12a for inducing an electrochemical reaction at the cathode 20. Meanwhile, the fuel gas flows from the fuel gas supply passage 34a and through the supply holes 46 into the fuel gas flow field 38 of the first separator 14. The fuel gas flows along the fuel gas flow field 38 in the direction of the arrow B. The fuel gas is supplied to the anode 22 of the MEA 12a for inducing an electrochemical reaction at the anode 22.

Consequently, in each of the MEAs 12a, the oxygen-containing gas, which is supplied to the cathode 20, and the fuel gas, which is supplied to the anode 22, are partially consumed in electrochemical reactions that take place in the first electrode catalyst layer 20a and the second electrode catalyst layer 22a, thereby generating electricity.

Next, the oxygen-containing gas, which is partially consumed at the cathode 20, flows along the oxygen-containing gas discharge passage 30b, and the oxygen-containing gas is discharged in the direction of the arrow A. Likewise, the fuel gas, which is partially consumed at the anode 22, flows through the discharge holes 48. The fuel gas flows along the fuel gas discharge passage 34b, and the fuel gas is discharged in the direction of the arrow A.

Further, the coolant that is supplied to the coolant supply passage 32a flows into the coolant flow field 40 between the first separator 14 and the second separator 16. Thereafter, the coolant flows in the direction of the arrow B. After the coolant cools the MEA 12a, the coolant is discharged into the coolant discharge passage 32b.

In this case, according to the first embodiment, as shown in FIG. 2, the frame shaped adhesive sheet 26, which has a bent shape, is interposed between the inner extension 24a of the resin frame member 24 and the outer marginal portion 18be of the MEA 12a. The inner marginal portion of the adhesive sheet 26 includes the overlapped portion 26a, which overlaps in the stacking direction with the surface of the outer marginal portion of the second gas diffusion layer 22b. The overlapped portion 26a is adhered to a porous portion on the outer periphery of the second gas diffusion layer 22b.

Therefore, in this structure, the resin frame member 24 and the MEA 12a are firmly and reliably adhered together through the adhesive sheet 26, in comparison with a structure in which one surface of the resin frame member 24 and one surface of the MEA 12a are adhered together. Thus, with a simple structure and process, for example, it is possible to reliably suppress peeling of the MEA 12a and the resin frame member 24 from each other.

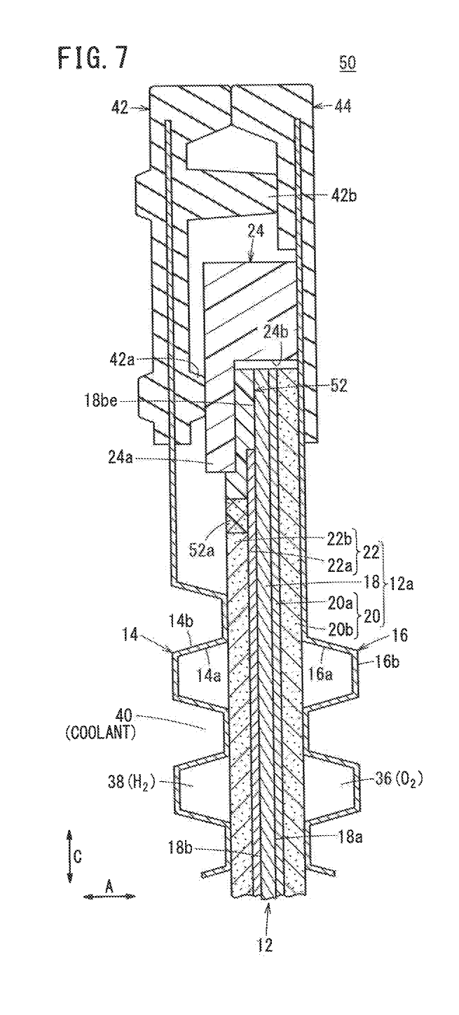

FIG. 7 is a cross sectional view showing main components of a solid polymer electrolyte fuel cell 50 according to a second embodiment of the present invention. Constituent elements thereof, which are identical to those of the fuel cell 10 according to the first embodiment, are denoted by the same reference numerals, and detailed description of such features is omitted. Similarly, in the third to sixth embodiments, which will be described later, constituent elements thereof, which are identical to those of the fuel cell 10 according to the first embodiment, are denoted by the same reference numerals, and detailed description of such features is omitted.

In the fuel cell 50, a frame shaped adhesive sheet 52 is disposed between the outer marginal portion 18be of the solid polymer electrolyte membrane 18 and the inner extension 24a of the resin frame member 24. The inner marginal portion of the adhesive sheet 52 includes an overlapped portion 52a, which overlaps in the stacking direction with the surface of the outer marginal portion of the second gas diffusion layer 22b. The overlapped portion 52a is impregnated with the outer marginal portion of the second gas diffusion layer 22b. For example, the impregnation process can be performed in the same manner as the adhesion process shown in FIG. 6. Briefly, the adhesive sheet 52 is melted by heating (hot melt), and a load (e.g., a pressing force or the like) is applied to the adhesive sheet 52. At this time, the load is applied while the region including the overlapped portion 52a is heated and melted.

As described above, according to the second embodiment, the resin frame member 24 and the MEA 12a can be firmly and reliably adhered together by the adhesive sheet 52. Thus, with a simple structure and process, the same advantages as those of the first embodiment are obtained. Further, for example, it is possible to reliably suppress peeling of the MEA 12a and the resin frame member 24 from each other.

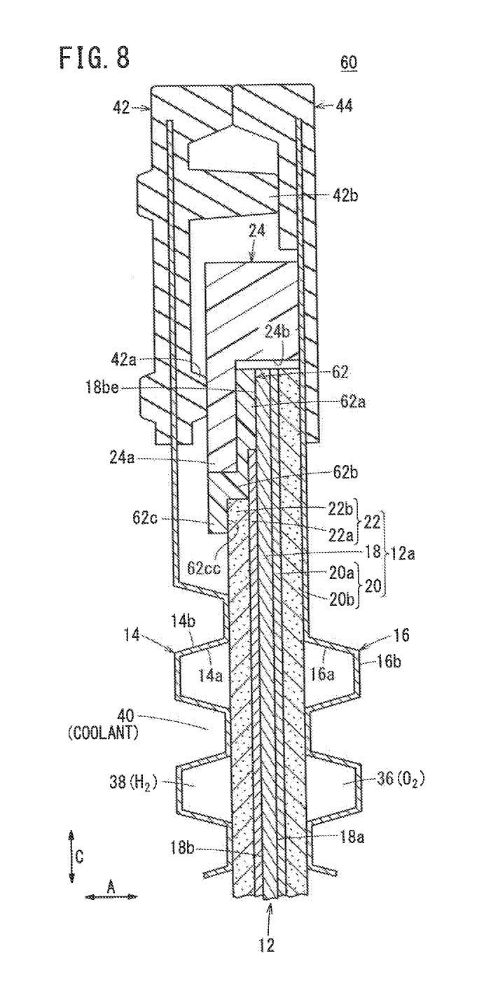

FIG. 8 is a cross sectional view showing main components of a solid polymer electrolyte fuel cell 50 according to a third embodiment of the present invention.

A frame shaped adhesive sheet 62 is disposed at an adhesion region between the outer marginal portion 18be of the solid polymer electrolyte membrane 18 and the inner extension 24a of the resin frame member 24. The adhesive sheet 62 is formed in the shape of a bent section before the adhesion process, and includes a flat portion 62a, which is formed between the inner extension 24a and the outer marginal portion 18be of the solid polymer electrolyte membrane 18. The flat portion 62a covers an area from the outer marginal portion 18be of the solid polymer electrolyte membrane 18 to the front end of the second electrode catalyst layer 22a.

The adhesive sheet 62 includes a first bent portion 62b between the front end of the inner extension 24a and the front end of the second gas diffusion layer 22b. The first bent portion 62b is bent substantially at a right angle from the flat portion 62a. A second bent portion 62c is provided at the front end of the first bent portion 62b. The second bent portion 62c is bent inwardly substantially at a right angle from the front end of the first bent portion 62b, and extends substantially in parallel with the flat portion 62a.

The second bent portion 62c includes an overlapped portion 62cc, which overlaps in the stacking direction with the surface of the outer marginal portion of the second gas diffusion layer 22b. The adhesive sheet 62 includes an overlapped portion, which directly contacts the second electrode catalyst layer 22a. The outer marginal portion of the adhesive sheet 62 is aligned substantially with the front ends of the solid polymer electrolyte membrane 18 and the cathode 20.

A thermoplastic or thermosetting adhesive, for example, is used as the adhesive sheet 62. According to the third embodiment, in the same manner as the first and second embodiments, the adhesive sheet 62 is formed using an ester based, acrylic based, or urethane based hot melt sheet.

Next, a method of producing the fuel cell 60 according to the third embodiment of the present invention will be described below.

First, an MEA 12a having different sizes of components is produced. Further, using a non-illustrated die (not shown), a resin frame member 24 is molded by injection molding. The resin frame member 24 includes a thin inner extension 24a.

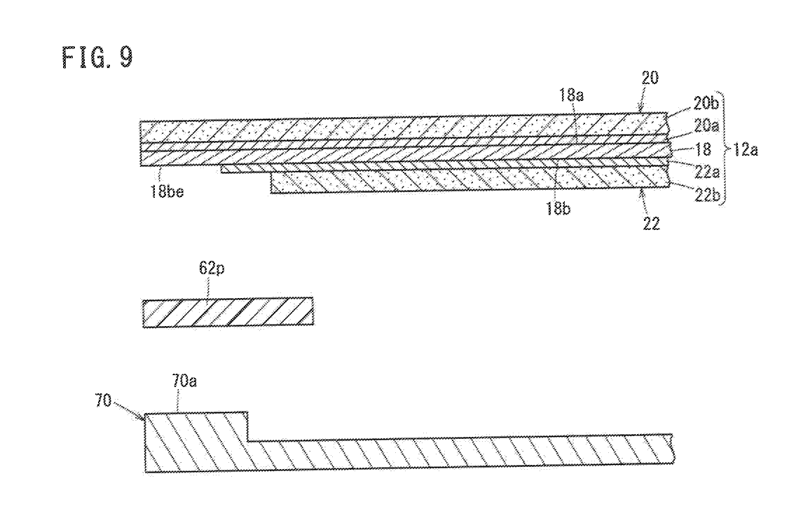

As shown in FIG. 9, a frame shaped flat adhesive sheet 62p is disposed between the MEA 12a and a heated die member 70. The die member 70 includes a press surface 70a that faces toward the MEA 12a, at a position corresponding to the inner extension 24a of the resin frame member 24.

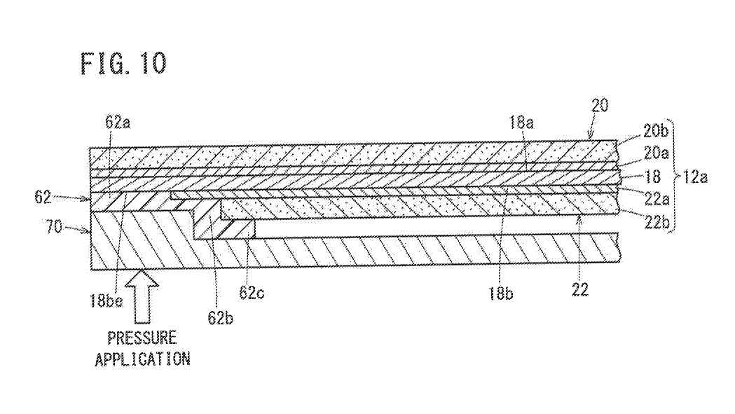

As shown in FIG. 10, press forming is applied to the flat adhesive sheet 62p between the die member 70 and the MEA 12a, to thereby form the adhesive sheet 62 having a bent shape. More specifically, the flat portion 62a, the first bent portion 62b, and the second bent portion 62c are molded integrally to form the adhesive sheet 62. The adhesive sheet 62 is disposed on the MEA 12a.

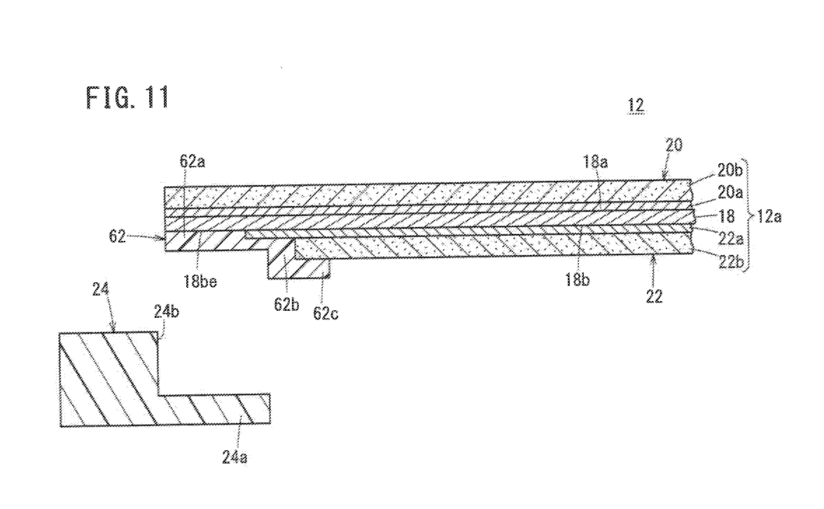

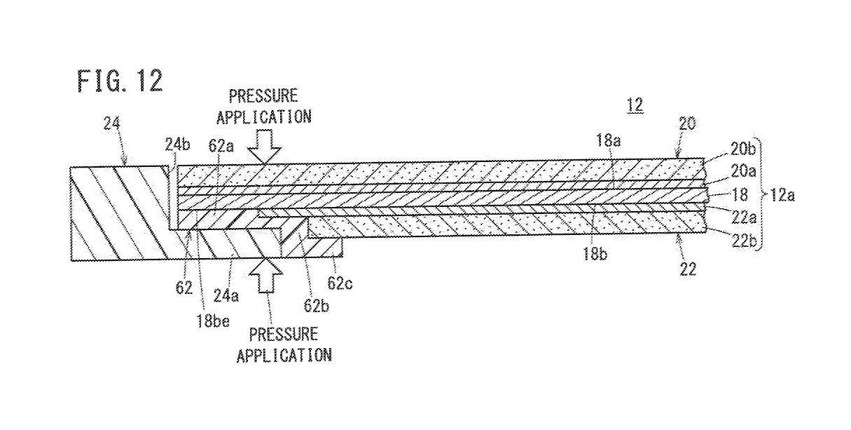

Then, after the die member 70 has been removed, as shown in FIG. 11, the resin frame member 24 is disposed in facing relation to the MEA 12a. The inner extension 24a of the resin frame member 24 and the MEA 12a are stacked together, such that the adhesive sheet 62 is interposed between the inner extension 24a and the MEA 12a. In this state, as shown in FIG. 12, the adhesive sheet 62 is melted by heating (hot melt), and a load (e.g., a pressing force) is applied to the adhesive sheet 62. In the adhesion method using the adhesive sheet 62, a technique using a hot press or a roll press is adopted. Further, either one sided heating or double sided heating may be used.

Therefore, the inner extension 24a and the solid polymer electrolyte membrane 18 are adhered together in order to produce the frame equipped membrane electrode assembly 12 having different sizes of components. As shown in FIG. 8, the frame equipped membrane electrode assembly 12 is sandwiched between the first separator 14 and the second separator 16. The first separator 14 contacts the inner extension 24a of the resin frame member 24, such that a load is applied to the frame equipped membrane electrode assembly 12 by the first separator 14 and the second separator 16.

In the third embodiment, as shown in FIG. 10, press forming is applied to the flat adhesive sheet 62p between the die member 70 and the MEA 12a, to thereby form the adhesive sheet 62 having a bent shape. Consequently, the frame shaped adhesive sheet 62 is molded beforehand, so as to have a shape that matches with the shape of the adhesion portion between the MEA 12a and the resin frame member 24 (see FIG. 11).

Thus, as shown in FIG. 12, when the adhesive sheet 62 is interposed at the adhesion portion between the inner extension 24a of the resin frame member 24 and the outer marginal portion of the MEA 12a, gaps are not formed at the adhesion portion due to molding failures of the adhesive sheet 62. Accordingly, it is possible to suppress stagnation of gas or air as much as possible. Further, with a simple process, it is possible to reliably and firmly join the MEA 12a and the resin frame member 24 together.

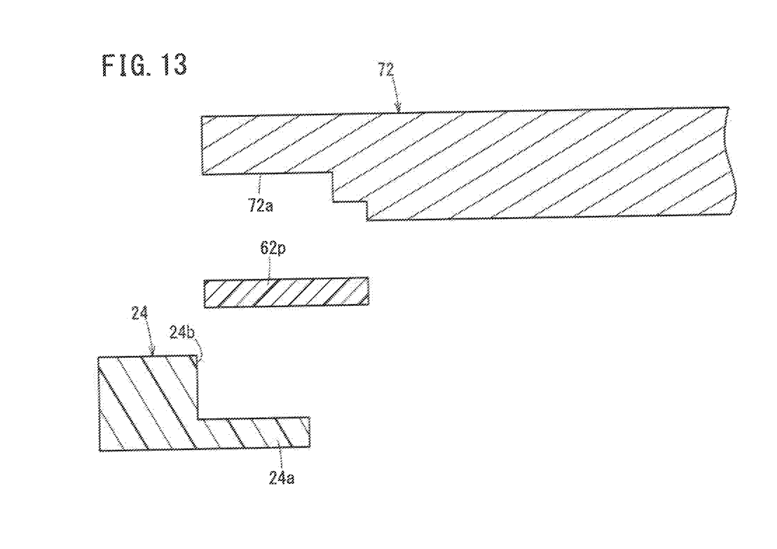

FIGS. 13 to 15 are views showing a method of producing a fuel cell 60 according to a fourth embodiment of the present invention.

As shown in FIG. 13, a flat adhesive sheet 62p is provided between a resin frame member 24 and a die member 72. The die member 72 includes a press surface 72a facing toward the inner extension 24a of the resin frame member 24, which corresponds to the outer marginal portion of the MEA 12a having different sizes of components.

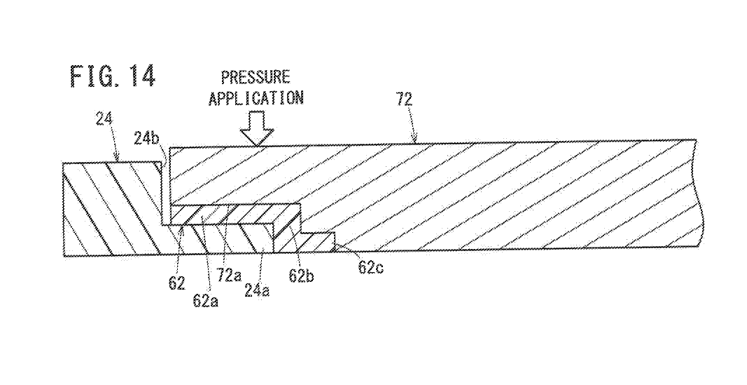

As shown in FIG. 14, press forming is applied to the flat adhesive sheet 62p between the heated die member 72 and the resin frame member 24, to thereby form the adhesive sheet 62 having a bent shape. More specifically, the flat portion 62a, the first bent portion 62b, and the second bent portion 62c are molded integrally to form the adhesive sheet 62. The adhesive sheet 62 is disposed on the resin frame member 24.

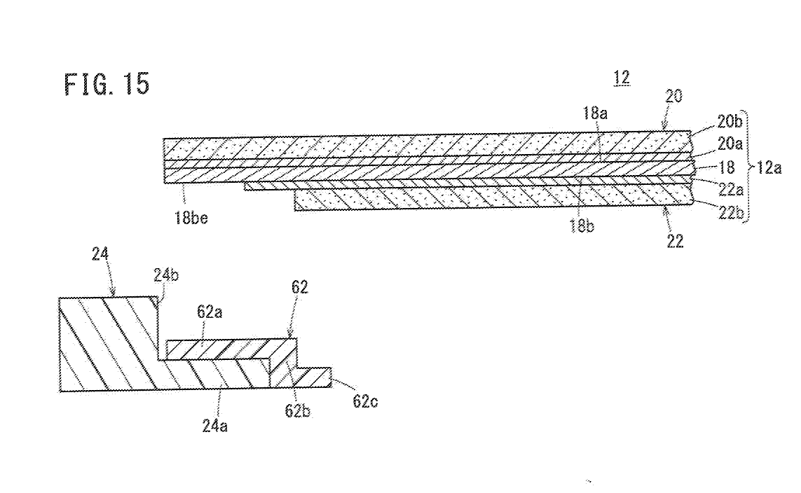

Then, after the die member 72 has been removed, as shown in FIG. 15, the MEA 12a is disposed in facing relation to the resin frame member 24. The inner extension 24a of the resin frame member 24 and the MEA 12a are stacked together, such that the adhesive sheet 62 is interposed between the inner extension 24a and the MEA 12a. In this state, as shown in FIG. 12, the adhesive sheet 62 is melted by heating (hot melt), and a load (e.g., a pressing force) is applied to the adhesive sheet 62.

In the fourth embodiment, using the die member 72 and the resin frame member 24, the frame shaped adhesive sheet 62 is molded beforehand, so as to have a shape that matches with the shape of the adhesion portion between the MEA 12a and the resin frame member 24 (see FIG. 14). Accordingly, the same advantages as those of the third embodiment are obtained. For example, with a simple process, it is possible to reliably and firmly join the MEA 12a and the resin frame member 24 together.

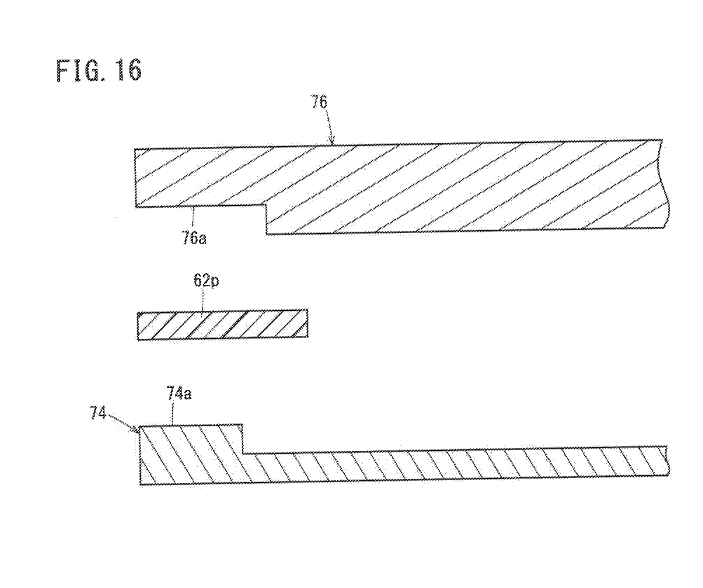

FIGS. 16 to 18 are views showing a method of producing the fuel cell 60 according to a fifth embodiment of the present invention.

As shown in FIG. 16, a flat adhesive sheet 62p is disposed between a plurality of die members, e.g., a first die member 74 and a second die member 76. The first die member 74 includes a press surface 74a, which corresponds to the inner extension 24a of the resin frame member 24, and the second die member 76 includes a press surface 76a, which corresponds to the outer marginal portion of the MEA 12a. The number of die members is not limited to two. Three or more die members may be used.

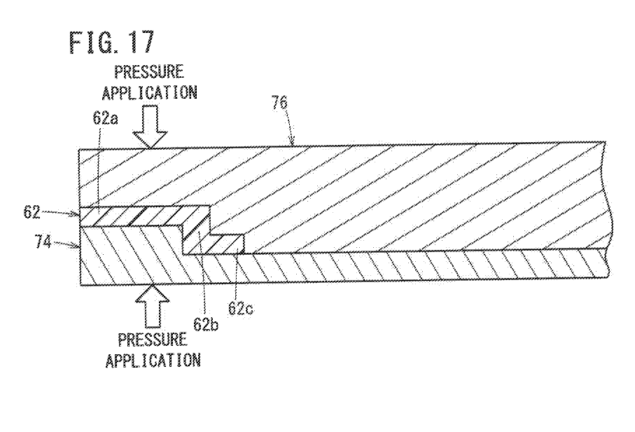

As shown in FIG. 17, press forming is applied to the flat adhesive sheet 62p between the heated first die member 74 and the heated second die member 76, to thereby form the adhesive sheet 62 having a bent shape. More specifically, the flat portion 62a, the first bent portion 62b, and the second bent portion 62c are molded integrally to form the adhesive sheet 62.

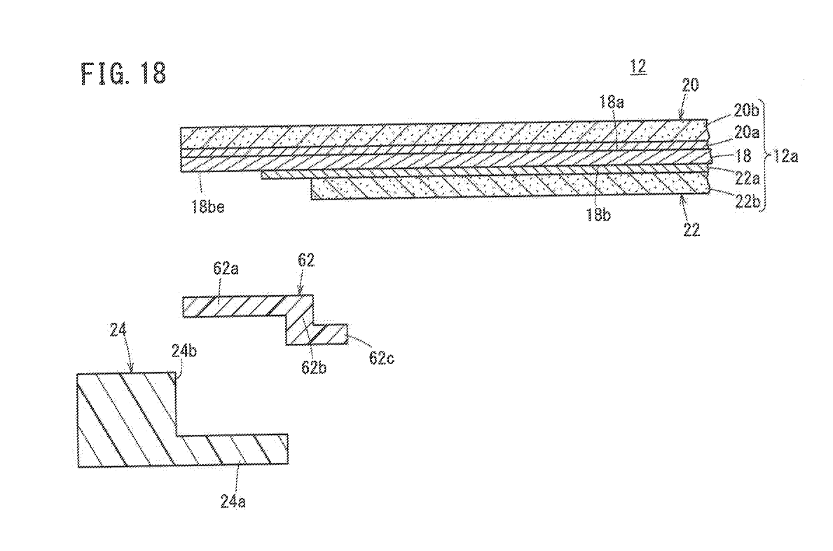

Then, after the first die member 74 and the second die member 76 have been removed, as shown in FIG. 18, the MEA 12a and the resin frame member 24 are stacked together, such that the adhesive sheet 62 is interposed between the MEA 12a and the resin frame member 24. In this state, as shown in FIG. 12, the adhesive sheet 62 is melted by heating (hot melt), and a load (e.g., a pressing force) is applied to the adhesive sheet 62.

In this case, according to the fifth embodiment, using the first die member 74 and the second die member 76, the frame shaped adhesive sheet 62 is molded beforehand in order to have a shape that matches with the shape of the adhesion portion provided between the MEA 12a and the resin frame member 24 (see FIG. 17). Accordingly, the same advantages as those of the third and fourth embodiments are obtained. For example, with a simple process, it is possible to reliably and firmly join the MEA 12a and the resin frame member 24 together.

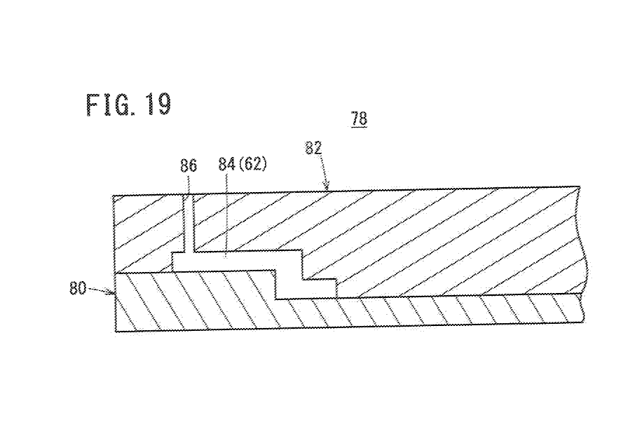

FIG. 19 is a cross sectional view showing a die device 78, which is used in a method of producing a fuel cell 60 according to a sixth embodiment of the present invention.

The die device 78 includes a first die 80 and a second die 82. When die clamping of the first die 80 and the second die 82 is carried out, a cavity 84 is formed between the first die 80 and the second die 82. The shape of the cavity 84 corresponds to the shape of the molded adhesive sheet 62. The second die 82 includes a sprue 86 for filling a hot melt agent, which is in a melted state, into the cavity 84. Instead of the sprue 86 of the second die 82, a sprue through which the hot melt agent fills may be provided in the first die 80.

In the sixth embodiment, in the die device 78, the hot melt agent, which is in a melted state, is poured from a plurality of sprues 86 and filled into the cavity 84. The adhesive sheet 62 is produced by hardening the hot melt agent.

When the adhesive sheet 62 is removed from the die device 78, the portion of the sprue is cut. Similar to the case of the aforementioned fifth embodiment and as shown in FIG. 18, the adhesive sheet 62 is sandwiched and stacked between the MEA 12a and the resin frame member 24. The adhesive sheet 62 is melted by heating (hot melt), and a load (a pressing force or the like) is applied to the adhesive sheet 62.

In the sixth embodiment, the same advantages as those of the third to fifth embodiments are obtained. For example, with a simple process, it is possible to reliably and firmly join the MEA 12a and the resin frame member 24 together.

While the invention has been particularly shown and described with reference to preferred embodiments, it will be understood that variations and modifications can be made to the embodiments by persons skilled in the art without departing from the scope of the invention as set forth in the appended claims.

What is claimed is:

1. A fuel cell including a frame equipped membrane electrode assembly, the frame equipped membrane electrode assembly comprising:
a membrane electrode assembly including a solid polymer electrolyte membrane, a first electrode provided on one surface of the solid polymer electrolyte membrane, and a second electrode provided on another surface of the solid polymer electrolyte membrane, the first electrode including a first catalyst layer and a first gas diffusion layer, and the second electrode including a second catalyst layer and a second gas diffusion layer, wherein a surface size of the first gas diffusion layer is larger than a surface size of the second gas diffusion layer; and
a resin frame member joined to the membrane electrode assembly, the resin frame member having a frame shape around an outer end of the solid polymer electrolyte membrane, and having a step portion forming a thin inner extension that protrudes toward the second gas diffusion layer;
wherein a frame shaped adhesive sheet is provided between the inner extension of the resin frame member and an outer marginal portion of the membrane electrode assembly; and
wherein an inner marginal portion of the adhesive sheet includes an overlapped portion, which overlaps in an electrode thickness direction with a surface of an outer marginal portion of the second gas diffusion layer.

2. The fuel cell according to claim 1, wherein the overlapped portion of the adhesive sheet is impregnated with the outer marginal portion of the second gas diffusion layer.

3. A method of producing a fuel cell including a frame equipped membrane electrode assembly, the frame equipped membrane electrode assembly comprising:
a membrane electrode assembly including a solid polymer electrolyte membrane, a first electrode provided on one surface of the solid polymer electrolyte membrane, and a second electrode provided on another surface of the solid polymer electrolyte membrane, the first electrode including a first catalyst layer and a first gas diffusion layer, and the second electrode including a second catalyst layer and a second gas diffusion layer, wherein a surface size of the first gas diffusion layer is larger than a surface size of the second gas diffusion layer; and
a resin frame member having a frame shape around an outer end of the solid polymer electrolyte membrane, and having a step portion forming a thin inner extension that protrudes toward the second gas diffusion layer;
wherein the membrane electrode assembly and the resin frame member are joined together;
the method comprising the steps of:
producing the membrane electrode assembly and the resin frame member separately;
producing a frame shaped adhesive sheet having an inner opening size which is smaller than an outer size of the second gas diffusion layer; and
adhering the inner extension of the resin frame member and an outer marginal portion of the membrane electrode assembly together through the adhesive sheet.

4. The production method according to claim 3, further comprising the step of impregnating the inner end of the adhesive sheet with the outer marginal portion of the second gas diffusion layer.

5. A method of producing a fuel cell including a frame equipped membrane electrode assembly, the frame equipped membrane electrode assembly comprising:
a membrane electrode assembly including a solid polymer electrolyte membrane, a first electrode provided on one surface of the solid polymer electrolyte membrane, and a second electrode provided on another surface of the solid polymer electrolyte membrane, the first electrode including a first catalyst layer and a first gas diffusion layer, and the second electrode including a second catalyst layer and a second gas diffusion layer, wherein a surface size of the first gas diffusion layer is larger than a surface size of the second gas diffusion layer; and
a resin frame member having a frame shape around an outer end of the solid polymer electrolyte membrane, and having a step portion forming a thin inner extension that protrudes toward the second gas diffusion layer;
wherein the membrane electrode assembly and the resin frame member are joined together;
the method comprising the steps of:
producing the membrane electrode assembly and the resin frame member separately;
molding a frame shaped adhesive sheet having a shape that matches with a shape of an adhesion portion provided between the membrane electrode assembly and the resin frame member; and
adhering the inner extension of the resin frame member and an outer marginal portion of the membrane electrode assembly together through the molded adhesive sheet.

6. The production method according to claim 5, wherein the molded adhesive sheet includes a flat portion formed between the inner extension and the outer marginal portion of the solid polymer electrolyte membrane extending outwardly beyond an end of the second gas diffusion layer; and
a first bent portion formed between a front end of the inner extension and a front end of the second gas diffusion layer, and which is bent from the flat portion substantially at a right angle; and
a second bent portion bent inwardly from the front end of the second gas diffusion layer substantially at a right angle, and extending substantially in parallel with the flat portion.

7. The production method according to claim 6, further comprising the steps of:
molding the adhesive sheet between a die member and the membrane electrode assembly, and disposing the molded adhesive sheet on the outer marginal portion of the membrane electrode assembly; and
adhering the inner extension of the resin frame member and the outer marginal portion of the membrane electrode assembly together through the molded adhesive sheet.

8. The production method according to claim 6, further comprising the steps of:
molding the adhesive sheet between a die member and the inner extension of the resin frame member, and disposing the molded adhesive sheet on the resin frame member; and
adhering the inner extension of the resin frame member and the outer marginal portion of the membrane electrode assembly together through the molded adhesive sheet.

9. The production method according to claim 6, further comprising the steps of:
molding the adhesive sheet between a plurality of die members; and
adhering the inner extension of the resin frame member and the outer marginal portion of the membrane electrode assembly together through the molded adhesive sheet.
